(19) United States
(12) Patent Application Publication
(10) Pub. No.: US 2014/0359735 A1
(43) Pub. Date: Dec. 4, 2014

(54) MAINTAINING APPLICATION SESSION CONTINUITY ACROSS DEVICES

(71) Applicants: Doron Lehmann, Kfar Vradim (IL); Eyal Nathan, Tel Aviv (IL); Nimrod Barak, Tel Aviv (IL)

(72) Inventors: Doron Lehmann, Kfar Vradim (IL); Eyal Nathan, Tel Aviv (IL); Nimrod Barak, Tel Aviv (IL)

(73) Assignee: SAP PORTALS ISRAEL LTD, Ra anana (IL)

(21) Appl. No.: 13/904,544

(22) Filed: May 29, 2013

(51) Int. Cl. H04L 29/06

(52) U.S. Cl. CPC H04L 63/0884
USPC 726/7; 709/227

(57) ABSTRACT

The present disclosure describes methods, systems, and computer program products for maintaining application session continuity across different devices. One computer-implemented method includes identifying a first application session of an application executing within a portal environment. The first application session of the application is associated with a first user who is operating at a first device. A representation of an application state for the first application session of the application is stored. A request is received to execute a second application session of the application within the portal environment from the first user operating at a second device different form the first device. The second application session of the application can be instantiated for execution within the portal environment. The second application session is instantiated to a state corresponding to the stored representation of the application state of the first application session.

### BACKGROUND

Electronic devices have advantages for use in different places and at different times. For example, a desktop computer is stationary and suitable for powerful and efficient computation, a laptop computer is portable for use at home and/or travel, a tablet is also convenient and versatile for portable use, and a smartphone integrates multiple functionalities into one pocket-size device. As wireless technology continues to develop, these devices can access the Internet and other networks in wider areas and at higher speeds. Via these networks, a user can create and consume data from a common platform on these different devices.

### SUMMARY

The present disclosure relates to computer-implemented methods, computer-readable media, and computer systems for maintaining application session continuity across different devices. One computer-implemented method includes identifying a first application session of an application executing within a portal environment. The first application session of the application is associated with a first user who is operating at a first device. A representation of an application state for the first application session of the application is stored. A request is received to execute a second application session of the application within the portal environment from the first user operating at a second device different form the first device. The second application session of the application can be instantiated for execution within the portal environment. The second application session is instantiated to a state corresponding to the stored representation of the application state of the first application session.

The foregoing and other implementations can each optionally include one or more of the following features:

A first aspect, combinable with the general implementation, wherein the first device is a desktop computer and the second device is a mobile device.

A second aspect, combinable with the general implementation, further includes storing a representation of the application state for the second application session of the application.

A third aspect, combinable with the general implementation, wherein storing the representation of the application state for the first application session of the application is stored in response to a request from the first user to end the first application session.

A forth aspect, combinable with the general implementation, further includes authenticating the first user on the second device within the portal environment prior to instantiating the second application session of the application.

A fifth aspect, combinable with the general implementation, further includes upon authentication of the first user on the second device, associating the second device with the application state of the first application session.

A sixth aspect, combinable with the general implementation, wherein authenticating the first user on the second device within the portal environment prior to instantiating the second application session of the application further includes opening an authentication session prior to providing access to the application state. The authentication session provides restricted access to the application state. Authentication credentials are received from the first user at the second device to confirm the identity of the first user. Upon validating the received authentication credentials from the first user, the authentication session is closed. The second application session of the application is instantiated to provide the first user access to the application state of the first application session.

A seventh aspect, combinable with the general implementation, wherein the first application session is active when the request to execute the second application session of the application is received. The first application session is closed.

An eighth aspect, combinable with the general implementation, further includes receiving data external to the application for inclusion within the application state from the second device during the second application session. A representation of the application state of the second application session is stored. The representation of the application sate of the second application session includes the received data.

A ninth aspect, combinable with the general implementation, wherein the second device includes a mobile device, and wherein the data external to the application includes at least one of a location of the mobile device, environmental data collected by the mobile device, and audio or visual data from the mobile device.

A tenth aspect, combinable with the general implementation, wherein the representation comprises a partial application state sufficed to place later application sessions in relatively the same state as the application state for the first application session.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The subject matter described in this specification can be implemented to realize one or more of the following advantages. Maintaining application session continuity enables users to conveniently resume to application sessions when the users switch between different devices. For example, a user may start an application session on a first device, such as a desktop computer. The user then goes to a meeting and starts a second application session on a second device, such as a laptop computer. The second application session can resume to an application state of the first application session. This allows the user to continue working on the application session without interruption (e.g., requirement for changing, adding, redefining, or recreating the second application session to match the application state of the first application session). In addition, the initiation of the second application session on the second device can automatically terminate the first application session on the first device. For new data captured or generated at the second application session on the second device (e.g., using a webcam), the new data can be synchronized and propagate through different devices of the user, therefore maintaining data continuity. Other advantages will be apparent to those skilled in the art.

While generally described as computer implemented software embodied on tangible media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example portal system for maintaining application session continuity across devices.

FIG. 2 illustrates an application example where continuity of an application state is followed at different times, locations, and devices.

FIG. 3 illustrates a communication diagram between different devices and a corresponding portal server.

FIG. 4 is an example user interface presented upon user authentication during log-in.

FIG. 5 is a flow chart illustrating an example method for maintaining application session continuity across devices.

FIG. 6 is a flow chart illustrating an example method for authenticating a user for instantiating a second application session.

### DETAILED DESCRIPTION

This disclosure generally describes computer-implemented methods, computer-program products, and systems for maintaining application session continuity cross devices.

The subject matter described in this specification can be implemented to realize one or more of the following advantages, among others. For example, maintaining application session continuity enables users to conveniently resume to application sessions when the users switch between different devices. In one instance, a user may start an application session on a first device, such as a desktop computer. The user may then go to a meeting and start a second application session on a second device, such as a laptop computer. The second application session can resume to an application state of the first application session. This allows the user to continue working on the application session without interruption (e.g., requirement for changing, adding, redefining, or recreating the second application session to match the application state of the first application session). In addition, the initiation of the second application session on the second device can automatically terminate the first application session on the first device. For new data captured or generated at the second application session on the second device (e.g., using a webcam), the new data can be synchronized and propagate through different devices of the user, therefore maintaining data continuity. Other advantages will be apparent to those skilled in the art.

Different electronic devices can access a common portal server and execute applications thereon. For example, desktop computers, smartphones, tablets, and other suitable devices can allow a user to log onto a portal server via internet (e.g., wired or wireless) and respectively instantiate a business application. Each business application may associate a respective application session to certain common credentials, files, databases, or configurations. This provides flexibility and convenience for the user to exploit advantageous features of a particular device. For example, a desktop computer can be used for high processing speeds, a tablet can be used for ease of presentation, and a smartphone can provide pocket size convenience. Any of these devices can also be used based on a user's location or based on a device that is most convenient. In many instances, a user may switch between different devices when working at different times and locations. In others, two or more devices may be used in a single location, such as an office or meeting room. Often, the user may need to reload files, reconfigure settings, navigate to a previous environment, or input additional data for an application session.

This disclosure describes maintaining continuity for an application session across different devices, such that a user can effortlessly later resume his work on a different device, in the last working state created on a previous device. For example, the user can start a first application session of a business application executing within a portal environment at a first device. The user can later instantiate a second application session of the same business application within the portal environment at a second device. The second application session is instantiated to a state corresponding to the application state of the first application session. The portal environment can manage both an application session and a security session to securely associate the application state with the user of both application sessions. Therefore on the user side, minimal input is needed from the user to resume the most recent application state and maintain application session continuity across devices.

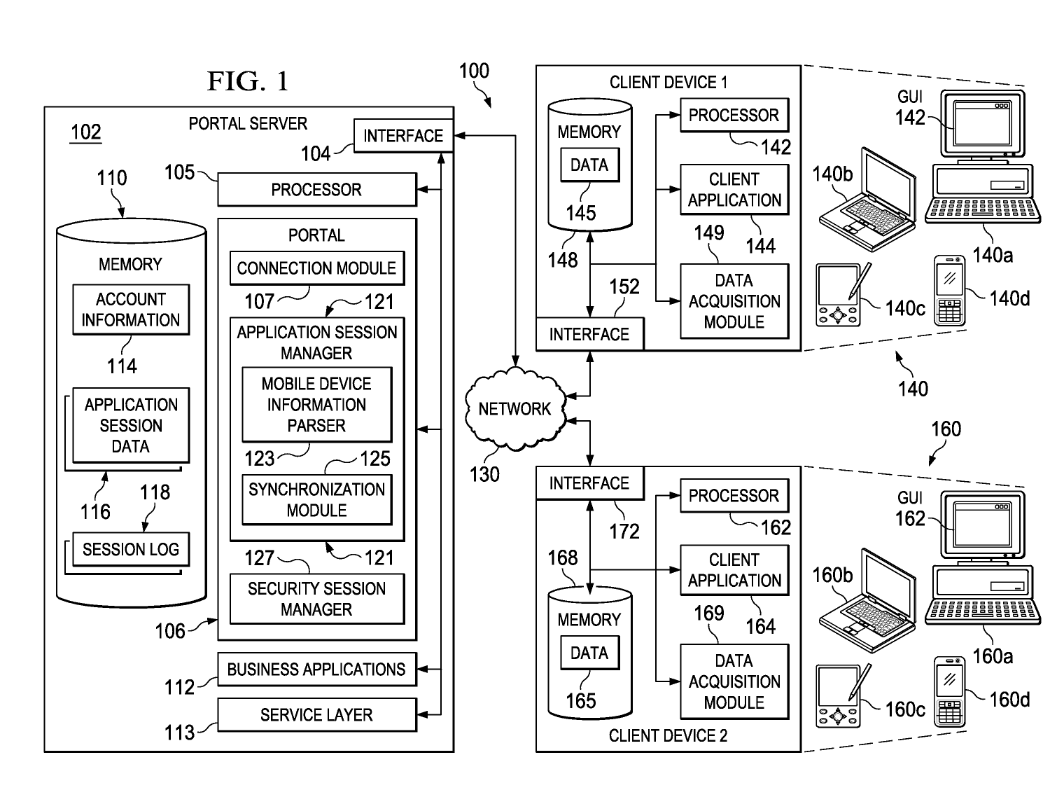

FIG. 1 is a block diagram illustrating an example portal system 100 for maintaining application session continuity across devices. The illustrated example portal system 100 includes or is communicably coupled with a portal server 102. At a high level, the portal server 102 is an electronic computing device operable to receive, transmit, process, store, or manage data and information associated with the example portal system 100. Generally, the portal server 102 allows users to navigate to, view, compose, modify, delete, and deploy applications (e.g., business applications) and their associated documents, for instance, using an enterprise portal system allowing for remote access into a centralized application or application suite. Specifically, the described computer-implemented methods, software, and systems provide functionality for maintaining continuity in the applications of a portal through one or more graphical user interfaces (GUIs) providing a user with a presentation of data provided by or communicated within the example portal system 100.

The portal server 102 is responsible for receiving application requests, such as requests for specified business applications from one or more client applications. For example, two different client devices 140 and 160 are shown in FIG. 1. Each client device 140 or 160 has a corresponding client application 144 or 164. The client applications 144 and 164 can request and execute business applications 112 from the portal server 102 via the network 130. The business applications 112 are accessed using a portal 106 that provides connection and security functionalities. The portal 106 includes an application session manager 121 and a security session manager 127 to maintain application session continuity in the portal 106 between the client device 140 and the client device 160. According to one implementation, the portal server 102 may also include or be communicably coupled with an e-mail server, a web server, a caching server, a streaming data server, and/or other suitable server.

The portal server 102 of FIG. 1 includes an interface 104, a processor 105, the portal 106, a memory 110, one or more business applications 112, and a service layer 113. At a high level, the client devices 140 and 160 can access the portal server 102 via the network 130. The client devices 140 or 160 can access the business applications 112 using a connection module 107 at the portal 106. The business applications 112 accessed from the client devices 140 or 160 can be managed by an application session manager 121 and a security session manager 127. At a high level, the application session manager 121 can instantiate and manage an application session on the client application, web browser, or native client executing at a client device. The security session manager 127 can authenticate a user account and associate the user account with a stored application state of the application session manager 121. Details of the collaboration between the application session manager 121 and the security session manager 127 to maintain the application session continuity are further discussed below.

The portal 106 is a framework for integrating information, people, and processes across organizational boundaries. For example, the portal 106 can be an enterprise portal, an enterprise information portal, an enterprise resource portal, a corporate portal, or the like. The portal 106 may be accessed in a form of a website presented in a generic web browser, via a portal-related client-side application, or through any other suitable method. The portal 106 provides a centralized user interface for the client devices 140 or 160 to access various portal contents, including the business applications 112 and associated data stored in the memory 110. The portal 106 includes a connection module 107, the application session manager 121, and the security session manager 127. The connection module 107 enables one or more client devices to access the business applications 112 once logged onto the portal 106. The business applications 112 can include software or set of computer programs that are used by business users to perform various business functions. The business applications 112 can be used to increase productivity, to measure productivity, and/or to perform business functions accurately. The business applications 112 can be executed at the client devices 140 or 160 using the connection function provided by the connection module 107.

The application session manager 121 initiates, terminates, stores, and otherwise manages application sessions of the business applications 112 based on communications with the security session manager 127 and other components (e.g., the connection module 107) of the portal 106. For example, upon receiving a request from a client device to initiate a business application 112, the application session manager 121 can start an application session corresponding to the request (e.g., based on device information, user account information, related data, etc.). The application session manager 121 can later store updated information of the application session and terminate the application session. Further, the application session manager 121 includes a mobile device information parser 123 and a synchronization module 127.

The mobile device information parser 123 can identify model information and/or configuration specifications of the requesting device and associate the information and/or specifications with requested application sessions. For example, the mobile device information parser 123 can associate a first device with a first request to launch a business application session. The mobile device information parser 123 may later associate a second device with a second request to launch the same business application session. The mobile device information parser 123 can relay information with the security session manager 127 to identify user account information, location information, potential usage conflicts, default priorities, and other information in the first and the second requests to handle application session instantiation. When the second request from the second device is authenticated, the first application session executed on the first device is stored (or alternatively, a representation of the application state of first application session is stored); and the first application session (or alternatively, the application state) is replicated to be the second application session on the second device.

In some implementations, when a client device has successfully initiated one or more business application sessions at the portal 106, the application session manager 121 can identify a first application session of a specific business application associated with the client device and its user's account information. The application session manager 121 can store a representation of an application state for the first application session. When the application session manager 121 receives a request from a second, different device to execute a second application session of the specific business application at the portal 106, the application session manager 121 can instantiate the second application session to a state corresponding to the stored representation of the application state of the first application.

The synchronization module 125 can synchronize data between a client device and the data associated with the business applications 112. Specifically, application session data 116 in the memory 110 can be synchronized with data generated or acquired at the connected client device. For example, a user can capture an image or acquire other data (e.g., audio recordings, video recordings, typed-in data, etc.) with the client device. The captured image or acquired data can be assigned to a specific business application (e.g., a business application from the portal server 102 and executed or associated with one of the client applications). When the client device connects to the portal 106, the user account information will be authenticated for the specific business application. Upon successful authentication, the synchronization module 125 can transfer the newly captured image to the corresponding business application's application session data 116. In some implementations, the application session data 116 may be updated by different users accessing the portal server 102. The updated portion of the application session data 116 may also be transferred to the client device by the synchronization module 125.

The security session manager 127 authenticates user account information associated with each application session connection request from client devices. For example, a user uses the first client device 140 to establish a first application session of the business application 112. The user, at a later time, uses the second client device 160 to establish a second application session of the business application 112. Prior to instantiating the second application session, the security session manager 127 opens a security session before providing access to the stored application state of the first application session, thereby providing restricted access to the stored application state. Upon receiving correct authentication credentials from the user on the second device 160, the security session manager 127 can confirm or validate the identity of the user, and further, can associate the user with the application session from the first user device 140. The security session manager 127 can then close the authentication session and instantiate the second application session of the business application 112 to provide the user access to the application state of the first application session.

In some implementations, the security session manager 127 identifies and authenticates users of the client devices 140 and 160. For example, one or more authorization/authentication criteria used by the security session manager 127 may include a user name, a user role, a user group, and the associated authentication methods (e.g., password, biometric data, or other suitable authentication data). In one example scenario, a user requests to access the business application 112 from the client device 140. The user may first log onto the portal 106 via the client device 140 with identification and authentication information, such as user name and password. The user identification can include or be associated with a role and/or certain administrative power to the user in the portal 106, such as access to certain business application 112. Some of the business applications 112 can require additional permission, and the requested content can only be accessed and/or displayed when the client device 140 is determined to provide qualified credentials (e.g., geo-location, device compatibility, or user role permission).

In some implementations, the security session manager 127 initiates security sessions for a particular user to access a common application session (e.g., one application session and multiple security sessions). For example, the user can access the particular business application 112 using the first client device 140 and can further request to initiate an application session. The security session manager 127 initiates a first security session for the request. Upon validation, the security session manager 127 enables the first device 140 to instantiate the requested application session. The first application session and its state can later be stored at the portal server 102's memory 110 (e.g., in the application session data 116), for instance, when the user logs out of the first application session. Alternatively, the first application session and its state can be stored in response to a request for a second application session at a second device by the same (authenticated) user. The user's activities related to the first application session may also be recorded at the session log 118. Subsequently, the user can use the second client device 160 for requesting a continued application session at the second client device 160, such that the previously stored application session and its state are provided during the second application session. In some instances, this may be considered a single application session, while in others, this may be considered two application sessions sharing state information, such that the cross-device application session maintains a single, extended application session on multiple devices. The security session manager 127 initiates a second security session for the second request. Upon validation, the security session manager 127 enables the second client device 160 to access and re-instantiate the stored application session and its state.

In some implementations, the security session manager 127 initiates security sessions corresponding to application sessions requested from multiple client devices. That is, each application session to be instantiated on a client device is associated with a corresponding security session (e.g., multiple application sessions and their corresponding security sessions). For example, when a user uses a client device to access a business application 112, the security session manager 127 initiates a security session that authenticates the user's account information. Upon validation, the security session further relates to the application session manager 121 for instantiating an application session. Each application session and its security session can be correlated and saved in the session log 118 of the memory 110.

The memory 110 includes account information 114, application session data 116, and session log 118. Although illustrated as a single memory 110 in FIG. 1, two or more memories may be used according to particular needs, desires, or particular implementations of the example portal system 100. While memory 110 is illustrated as an integral component of the portal server 102, in alternative implementations, memory 110 can be external to the portal server 102 and/or the example portal system 100. The memory 110 may include any memory or database module and may take the form of volatile or non-volatile memory including, without limitation, magnetic media, optical media, random access memory (RAM), read-only memory (ROM), removable media, or any other suitable local or remote memory component. The memory 110 may store various objects, object models, and data, including classes, frameworks, applications, backup data, business objects, jobs, web pages, web page templates, database tables, process contexts, repositories, and any other appropriate information including any parameters, variables, algorithms, instructions, rules, constraints, or references thereto associated with portal 106 and its functionality. In some implementations, including a cloud-based system, some or all of the memory 110 may be stored remote from the portal server 102, and communicably coupled to the portal server 102 for usage. Specifically, memory 110 can store account information 114, session log 118 as well as the application session data 116. Some or all of the elements illustrated within memory 110 may be stored external to the memory 110.

The account information 114 includes information related to user accounts, such as user security and user profiles. The account information 114 can be used by the security session manager to authenticate user requests sent from client devices as well as by the application session manager 121 to identify client devices that have been registered with the business applications 112. The application session data 116 includes data installed for or generated from one or more application sessions. For example, the application session data 116 can include default parameters for configuration and/or instantiation of the application session, as well as data generated, modified, or added during the application session. In some instances, the application session data 116 stores data representing current and/or previous application states of the corresponding application sessions. The application session data 116 may be used in subsequent and separate application sessions to recreate the same application state as the state previously stored for a particular user. In some instances, the synchronization module 125 can synchronize data external to the application (e.g., data captured or generated at client devices) to the application session data 116. The session log 118 can record user activities related to time, location, and device information, among others. For example, the session log 118 may monitor and store when, where, and which client device of a particular user account has attempted to instantiate or has instantiated an application session.

In the illustrated example of FIG. 1, any and/or all of components of the portal server 102, both hardware and/or software, may interface with each other and/or the interface using a service layer 113 and/or an application programming interface (not shown). The service layer 113 provides software services to the example portal system 100. The functionality of the portal server 102 may be accessible for all service consumers using this service layer 113. Software services, such as those provided by the service layer 113, provide reusable, defined business functionalities through a defined interface. For example, the interface may be software written in JAVA, C++, or other suitable language providing data in extensible markup language (XML) format or other suitable format.

While illustrated as an integrated component of the portal server 102 in the example portal system 100, alternative implementations may illustrate the business applications 112, the memory 110, or the service layer 113 as stand-alone components in relation to other components of the example portal system 100. Moreover, any or all parts of the business applications 112 or the service layer 113 may be implemented as child or sub-modules of another software module, enterprise application, or hardware module without departing from the scope of this disclosure.

The portal server 102 includes an interface 104. Although illustrated as a single interface 104 in FIG. 1, two or more interfaces 104 may be used according to particular needs, desires, or particular implementations of the example portal system 100. The interface 104 is used by the portal server 102 for communicating with other systems in a distributed environment—including within the example portal system 100—connected to the network 130, for example, the client device 140 or 160 as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example portal system 100.

The portal server 102 includes a processor 105. Although illustrated as a single processor 105 in FIG. 1, two or more processors may be used according to particular needs, desires, or particular implementations of the example portal system 100. Generally, the processor 105 executes instructions and manipulates data to perform the operations of the portal server 102. Specifically, the processor 105 executes the functionality required to provide a location-based application content security mechanism to a web portal.

The client devices 140 and 160 can be any computing device operable to connect to or communicate with at least the portal server 102 using the network 130. In general, the client device 140 or 160 comprises an electronic computing device operable to receive, transmit, process, and store any appropriate data associated with the example portal system 100. Each of the client devices 140 and 160 respectively includes a processor 142 or 162, client applications 144 and 164, a memory 148 or 168, a data acquisition module 149 or 169, and/or an interface 152 or 172.

The client applications 144 and 164 are any type of application that allow the client devices 140 and 160 to navigate to/from, request, view, edit, delete, and or manipulate onboard content. In some implementations, the client applications 144 and 164 can be and/or include a web browser. Alternatively the client applications 144 and 164 may be native and/or client-side applications associated with the portal 106 and executing on their respective client device. In some implementations, the client applications 144 and 164 can use parameters, metadata, and other information received at launch to access a particular set of data from the portal server 102. Once a particular client applications 144 and 164 are launched, a user may interactively process a task, event, or other information associated with the portal 106 via the client application 144 and 164. Further, although illustrated as client applications 144 and 164, the client applications 144 and 164 may respectively be implemented as multiple client applications in the client device 140 and 160. In some implementations, the client applications 144 and 164 may act as a GUI interface for the memory 110 and/or other components of portal server 102 and/or other components of the example distributed computing environment 100.

The interfaces 152 and 172 are respectively used by the client device 140 or 160 for communicating with other computing systems in a distributed computing system environment, including within the example portal system 100, using the network 130. For example, the client devices 140 and 160 use the interface 152 or 172 to communicate with the portal server 102 (as well as other not illustrated systems) that are communicably coupled to the network 130. The interfaces 152 and 172 may be consistent with the above-described interface 104 of the enterprise server 102 or other interfaces within the example portal system 100. The processors 142 and 162 may be similar to or different than processor 105 of the portal server 102. Specifically, the processors 142 and 162 execute instructions and manipulate data to perform the operations of their respective client devices 140 or 160, including the functionality required to send requests to the portal server 102 and to receive and process responses from the portal server 102. The memory 148 and 168 may be consistent with memory 110 of the portal server 102, as well as any other suitable memory, and can store objects and/or data 145 and 165 associated with the purposes of the respective client devices 140 and 160, including site maps, cached data, container documents, GUI elements, and crowd-source information similar to that stored in memory 110 of portal server 102. In some implementations, the data 145 and 165 may include one or more of a location of the related client device, environmental data collected by the related client device, and audio or visual data captured using the related client device.

The data acquisition module 149 or 169 can be sensors, input device, or other data gathering or generating apparatus. For example, the data acquisition module 149 or 169 can include a global positioning system (GPS) receiver, a geo-location module based on signal triangulation using cellular or other types of wireless signals, a camera, a microphone, a touch screen, an accelerometer, a gyroscope, an infrared signal receiver, a Bluetooth receiver, and other data acquisition devices connected through universal serial bus (USB) and other data communication ports.

Further, the illustrated client devices 140 and 160 respectively include a GUI 142 and 162. The GUIs 142 and 162 interface with at least a portion of the example portal system 100 for any suitable purpose, including generating a visual representation of a web browser. The GUIs 142 and 162 may be used to view and navigate various web pages located both internally and externally to the portal server 102. In particular, the GUIs 142 and 162 may be used to perform functions for providing assisted portal navigation and crowd-based feedback consistent with this disclosure.

There may be any number of client devices associated with, or external to, the example portal system 100. For example, while the illustrated example portal system 100 includes the client devices 140 and 160 communicably coupled to the portal server 102 using the network 130, alternative implementations of the example portal system 100 may include any number of clients 140 suitable to the purposes of the example portal system 100. Additionally, there may also be one or more additional client devices external to the illustrated portion of the example portal system 100 that are capable of interacting with the example portal system 100 using the network 130. Moreover, while the client devices 140 and 160 are described in terms of being used by a single user, this disclosure contemplates that many users may use one client device, or that one user may use multiple client devices.

The illustrated client devices 140 and 160 are intended to encompass any computing device such as a desktop computer 140a or 160a, laptop/notebook computer 140b or 160b, wireless data port (not shown), tablet computing device 140c or 160c, smartphone 140d or 160d, personal data assistant (PDA), one or more processors within these devices, or any other suitable processing device. For example, the client devices 140 and 160 may comprise a computer that includes an input device, such as a keypad, touch screen, or other device that can accept user information, and an output device that conveys information associated with the operation of the portal server 102 or the client device 140, 160 itself, including digital data, visual and/or audio information, or a respective GUI 142 or 162, as shown with respect to the client devices 140 and 160.

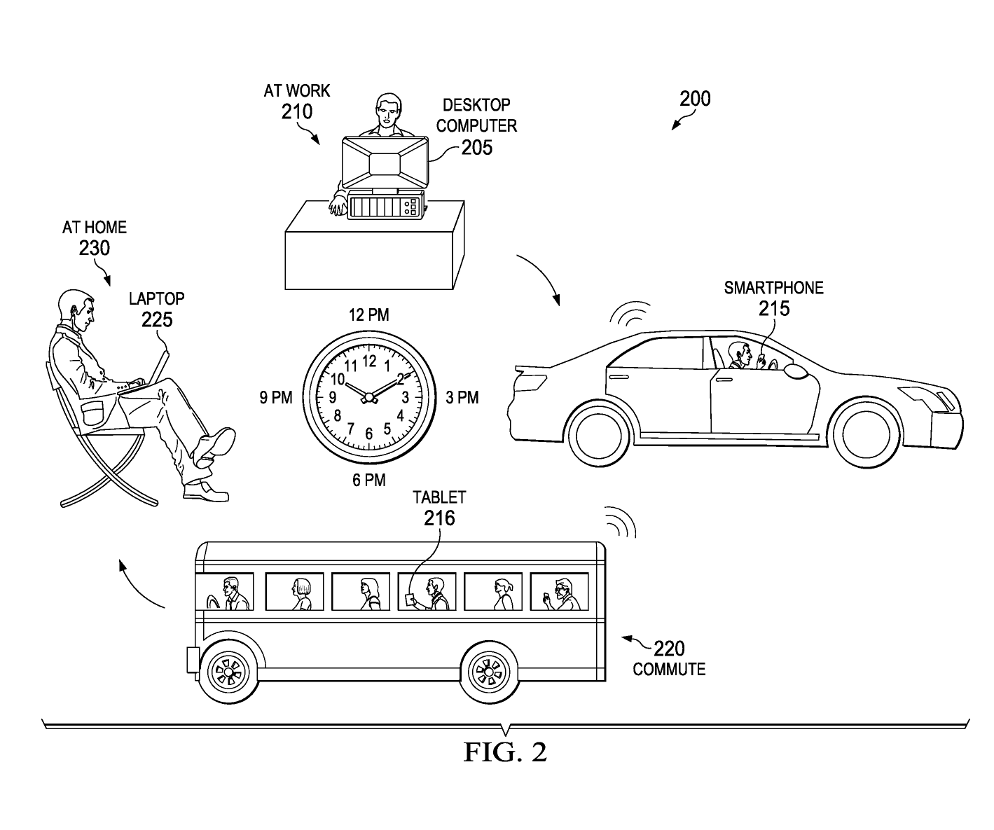

FIG. 2 illustrates an application example 200 where continuity of an application state is followed at different times, locations, and devices. The application example 200 includes three usage scenarios with different electronic devices. For example, in scenario 210 a user operates on a desktop computer 205 at work, in scenario 220 the same user operates on a smartphone 215 or a tablet 216 during a commute from the office, and in scenario 230 the same user operates on his laptop computer 225 at home. These scenarios illustrate how the user can take advantage of the continuity functions for the portal system 100 illustrated in FIG. 1.

For example, in scenario 210, the user uses the desktop computer 205 to access the portal 106 and create a first application session of the business application 112. A representation of the application state of the first application session is stored, such as at the application session data 116 described in FIG. 1. When the user leaves work for home, the user may use a different device, such as the smartphone 215 or the tablet 216, to access the portal 106 and access the business application 112. On the smartphone 215 or the tablet 216, a second application session is instantiated for execution within the portal 106 in the mobile environment. The second application session is instantiated to a state corresponding to the stored representation of the application state of the first application session. Thus, the user has a continuous application session to use on a different device without interruption.

Similarly, in scenario 230, the user can use a third different device, such as the laptop 225, to resume to the application state stored at the end of the second application session when accessing the portal 106. The method for maintaining session continuity can therefore enable different devices to continuously access application sessions of business applications at different times and places.

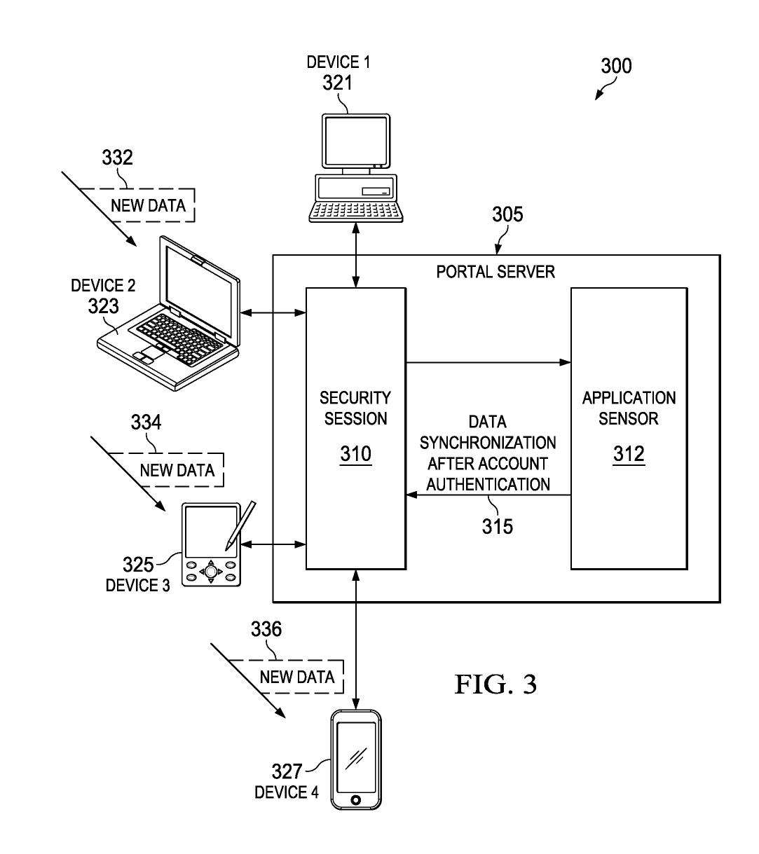

FIG. 3 illustrates a communication diagram 300 between different devices and a corresponding portal server 305. The portal server 305 allows multiple devices to simultaneously establish connections and upload new data to the associated business application under the same user account. For example, a user can use authorized credentials to initiate a security session 310 in the portal server 305 for one or more mobile devices (e.g., a desktop computer 321, a laptop computer 323, a tablet 325, and a smartphone 327). The security session 310, upon authentication of the user, may provide an application session for access or instantiation on each of the mobile devices. In some instances, the mobile devices can acquire new data. For instance, the laptop computer 323 may use a webcam, microphone, or other connected data acquisition device (e.g., from experimental equipment) to acquire new data 332. The tablet computer 325 may use an onboard camera, accelerometer, gyroscope, GPS, or other sensing devices to acquire new data 334. The smart phone 327 may use GPS receivers, infrared receivers, Bluetooth connectors, and other onboard data acquisition devices or connectors to acquire new data 336. The new data 332, 334, and 336 can include the location of the mobile device, a static image, a movie, an audio recording, a text string, or other data recorded from the data acquisition device.

After successful connection to the portal server 305 and authentication in the security session 310, the new data acquired at the mobile devices can be synchronized to a currently instantiated application session 312, as well as to the data storage supporting the currently instantiated application session 312. In some implementations, the currently instantiated application session 312 is executed on one particular mobile device, while the new data being synchronized to the currently instantiated application session 312 can be from multiple different mobile devices. This enables the user to have a continuous application session running while gathering data from one or more devices (and the particular sensors thereon) through the portal server 305.

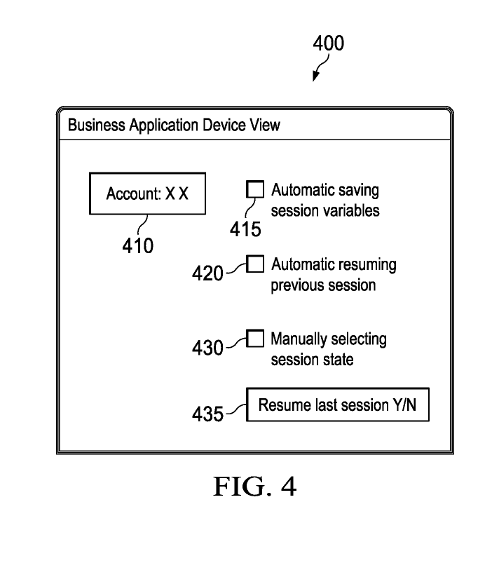

FIG. 4 is an example user interface 400 presented after user authentication during a login operation to a particular portal application providing cross-device application sessions. The user interface 400 shows a business application device view upon initiation of an application session. The illustrated user interface 400 includes account information 410, a saving option 415, an automatic resume option 420, a manual resume option 430, and a selection window 435 associated with the manual resume option 430. The account information 410 can include user account identification and allows a user to open an authentication interface for login purposes. The saving option 415 allows a user to select an automatic saving operation on session variables and data to provide cross-device continuity of the current application session. The automatic resume option 420 and the manual resume option 430 allow a user to select between the instantiation manners of a previously stored application session. For example, checking the automatic resume option 420 enables the user on the current device to automatically resume to the application state of a previous application session on a previous different device. Checking the manual resume option 430 enables the user on the current device to manually select if the current application session is to be restored to the previous one. Checking the manual resume option 430 can cause the selection window 435 to appear every time a new application session is to instantiate. The options presented in the user interface 400 may be presented in a dedicated UI, a tool box, a sidebar, and option panel, or any other suitable location within the user interface 400. In some instances, an administrator or power user may set one or more of these and other options for the user. These pre-set options may be permanently set, or they may allow users to modify and/or change some of the settings on their own.

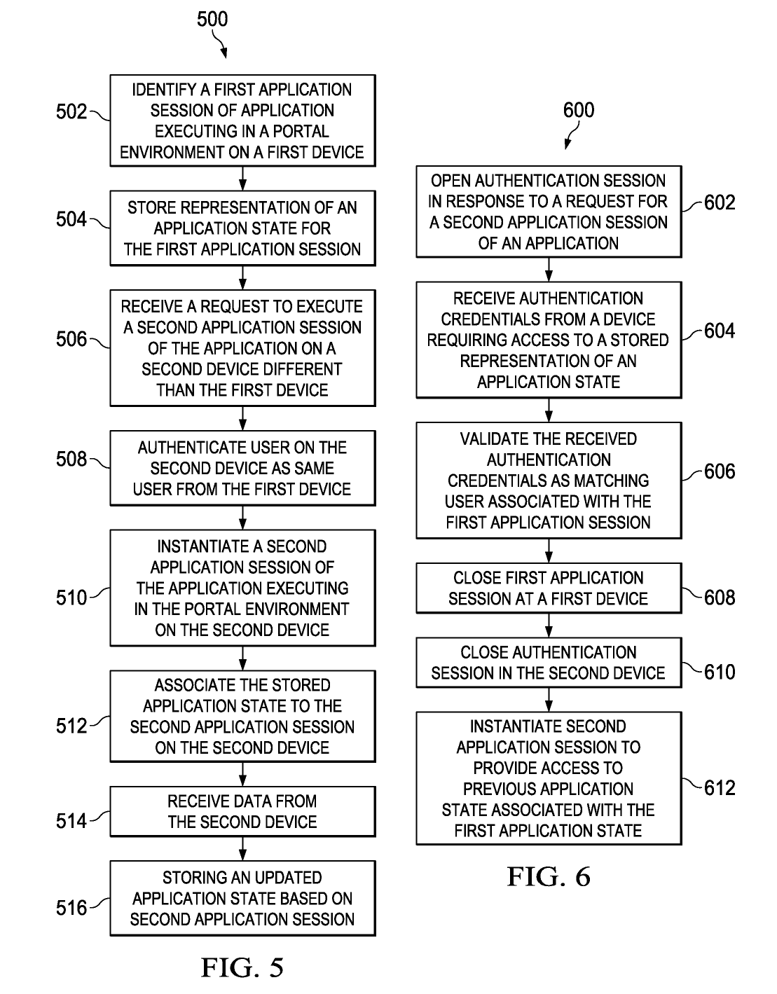

FIG. 5 is a flow chart 500 illustrating an example method for maintaining application session continuity across devices. The method can be used in a portal environment similar to the portal system 100 illustrated in FIG. 1, as well as in any other suitable environment.

At 502, a first application session of a business application executing in a portal environment on a user's first device can be identified. In some instances, a portal server may use an application session manager to manage the first application session. The first device can be a desktop computer or other stationary computation device.

At 504, representation of an application state for the first application session can be stored. The representation of the application state may include part or all set of parameters defined in or related to the current application state. The representation of the application state can be used to restore or recreate an application state at a second device (or later at the first device) to an application state substantially identical to the stored application state, such as by storing one or more parameters and other state information. For example, the representation can include a partial application state sufficient to place later application sessions into the same or equivalent state as the application state for the first application session. In some implementations, the storing operation is in response to a request from the user to end the first application session. In other implementations, the storing operation may be in response to receiving a request from the user at a second device asking to access the state data associated with the first application session (e.g., when the user logs on from a second device while still executing a first application session).

At 506, a request to execute a second application session of the application on a second device different than the first device is received. The second device can be a mobile device, such as a laptop computer, a tablet computer, a smartphone, a multimedia player, a camera, etc. In some instances, the received request can include user authentication information, as well as other relevant data associated with the request.

At 508, authenticates the user information from the second device is authenticated to determine that the user associated with the received request is the same as that of the first application session on the first device. The authentication procedure may be conducted by a security session manager, which initiates a security session to each application session request. The authentication procedure is, for example, conducted prior to instantiating a second application session of the application.

At 510, upon successful authentication of the second device, a second application session of the application is instantiated to execute in the portal environment on the second device.

At 512, the second application session is associated with or placed in a state corresponding to the stored representation of the application sate of the first application session. For example, the application state for the second application session can be recreated to replicate the most recently stored application state of the first application session. In some implementations, a common application session and its common state information can be stored and modified when accessed by different client devices or accounts. In this case, the common application session can be or can include the common application state.

At 514, data may be received from the second device. The data may be external to the application, and can be included or associated with the application state. For example, the data can be location of the second device, environmental data collected by the second device, audio and video data recorded on the second device. In some instances, the data may be managed by a synchronization function to be automatically transferred upon identification and authentication of the user account. In some instance, the data may include data generated or added by the user during the second application session.

At 516, the portal server stores an updated application state (or its representation) based on the second application session, for example, when the user ends the second application session.

FIG. 6 is a flow chart 600 illustrating an example method for authenticating a user prior to instantiating a second application session in a cross-device continuity situation, such as those described above. At 602, a security session can be opened in response to a request for a second application session of a business application.

At 604, authentication credentials can be received from the device that is requiring access to a stored representation of an application state of a first application session on a first device. For example, one or more authorization/authentication criteria can be used, such as a user name, a user role, a user group, and the associated authentication methods (e.g., password, biometric data, or other suitable authentication data). In some implementations, the user identification can include or be associated with a role and/or certain administrative power to the user in the portal, such as access to certain business applications. Some of the business applications may require additional permission, and the requested content can only be accessed and/or displayed when the client device is determined to provide qualified credentials (e.g., geo-location, device compatibility, or user role permission).

At 606, the received authentication credentials are validated as a matching user associated with the first application session.

At 608, the first application session at the first device is closed. For example, when the first application session is active while the request to execute the second application session of the business application is received, the first application session is closed.

At 610, the authentication session in the second device is closed.

At 612, the second application session is instantiated to provide access to previous application state associated with the first application state.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program, by way of example, can be based on general or special purpose microprocessors or both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/-R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method, the method comprising:
identifying a first application session of an application executing within a portal environment, the first application session of the application associated with a first user operating at a first device;
storing a representation of an application state for the first application session of the application;
receiving a request to execute a second application session of the application within the portal environment from the first user operating at a second device different from the first device; and
instantiating the second application session of the application for execution within the portal environment, wherein the second application session is instantiated to a state corresponding to the stored representation of the application state of the first application session.

2. The method of claim 1, wherein the first device is a desktop computer and the second device is a mobile device.

3. The method of claim 1, further comprising storing a representation of the application state for the second application session of the application.

4. The method of claim 1, wherein storing the representation of the application state for the first application session of the application is stored in response to a request from the first user to end the first application session.

5. The method of claim 1, further comprising authenticating the first user on the second device within the portal environment prior to instantiating the second application session of the application.

6. The method of claim 5, further comprising, upon authentication of the first user on the second device, associating the second device with the application state of the first application session.

7. The method of claim 5, wherein authenticating the first user on the second device within the portal environment prior to instantiating the second application session of the application includes:
opening a security session prior to providing access to the application state, the security session providing restricted access to the application state;
receiving authentication credentials from the first user at the second device to confirm the identity of the first user; and
upon validating the received authentication credentials from the first user:
closing the security session; and
instantiating the second application session of the application to provide the first user access to the application state of the first application session.

8. The method of claim 1, wherein the first application session is active when the request to execute the second application session of the application is received, the method further comprising closing the first application session.

9. The method of claim 1, further comprising:
receiving, from the second device during the second application session, data external to the application for inclusion within the application state; and
storing a representation of the application state of the second application session, the representation of the application state of the second application session including the received data.

10. The method of claim 9, wherein the second device comprises a mobile device, and wherein the data external to the application includes at least one of a location of the mobile device, environmental data collected by the mobile device, and audio or visual data from the mobile device.

11. The method of claim 1, wherein the representation comprises a partial application state sufficed to place later application sessions in relatively the same state as the application state for the first application session.

12. A non-transitory, computer-readable medium storing computer-readable instructions executable by a computer to:
identify a first application session of an application executing within a portal environment, the first application session of the application associated with a first user operating at a first device;
store a representation of an application state for the first application session of the application;
receive a request to execute a second application session of the application within the portal environment from the first user operating at a second device different from the first device; and
instantiate the second application session of the application for execution within the portal environment, wherein the second application session is instantiated to a state corresponding to the stored representation of the application state of the first application session.

13. The computer readable medium of claim 12, further comprises instructions to store a representation of the application state for the second application session of the application.

14. The computer readable medium of claim 12, wherein storing the representation of the application state for the first application session of the application is stored in response to a request from the first user to end the first application session.

15. The computer readable medium of claim 12, further comprises instructions to authenticate the first user on the second device within the portal environment prior to instantiating the second application session of the application.

16. The computer readable medium of claim 15, wherein authenticating the first user on the second device within the portal environment prior to instantiating the second application session of the application includes:
opening a security session prior to providing access to the application state, the security session providing restricted access to the application state;
receiving authentication credentials from the first user at the second device to confirm the identity of the first user; and
upon validating the received authentication credentials from the first user:
closing the security session; and
instantiating the second application session of the application to provide the first user access to the application state of the first application session.

17. The computer medium of claim 12, wherein the first application session is active when the request to execute the second application session of the application is received, the method further comprising closing the first application session.

18. The computer medium of claim 12, wherein the representation comprises a partial application state sufficed to place later application sessions in relatively the same state as the application state for the first application session.

19. A computer system, comprising:
at least one computer configured to:
identify a first application session of an application executing within a portal environment, the first application session of the application associated with a first user operating at a first device;
store a representation of an application state for the first application session of the application;
receive a request to execute a second application session of the application within the portal environment from the first user operating at a second device different from the first device; and
instantiate the second application session of the application for execution within the portal environment, wherein the second application session is instantiated to a state corresponding to the stored representation of the application state of the first application session.

20. The computer system of claim 19, further comprising at least one computer to authenticate the first user on the second device within the portal environment prior to instantiating the second application session of the application, wherein authenticating the first user on the second device within the portal environment prior to instantiating the second application session of the application includes:
opening a security session prior to providing access to the application state, the security session providing restricted access to the application state;
receiving authentication credentials from the first user at the second device to confirm the identity of the first user; and
upon validating the received authentication credentials from the first user:
closing the security session; and
instantiating the second application session of the application to provide the first user access to the application state of the first application session.
